(19) United States
(12) Patent Application Publication
(10) Pub. No.: US 2006/0203006 A1
(43) Pub. Date: Sep. 14, 2006

(54) Computer screen motion capture

(76) Inventor: Scott Georgeson, Aberfoyle Park (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/538,353

(22) PCT Filed: Dec. 11, 2003
(86) PCT No.: PCT/AU03/01654

§ 371 Date: Jun. 13, 2005

(30) Foreign Application Priority Data
Dec. 11, 2002 (AU) 2002953335

(51) Int. Cl. G09G 5/00

(52) U.S. Cl. 345/619; 707/104.1

(57) ABSTRACT

A computer screen capture method is described that consists of the following steps: capturing screen data at predetermined capture intervals of a selected area including the whole or part of a computer screen. Each successive captured screen data is compared with the immediately preceding captured screen data to determine what area of the screen changes within one or more smaller areas of the selected area. An event list is created having an event interval at least equal to or less than the said predetermined capture interval containing none, one or more entries per interval, wherein the entries maybe one or more of a unique reference to events representing visual change. Previous and successive said smaller areas of the selected area are recreated by playback of the relevant events in the event list. The previously captured area is compared with the current area to determine the minimum area of change that is stored as a minimum area A file is created containing at least minimum stored area, and an event list representing changes over time of the whole or part of the area of a computer screen. The various files can be compressed for transmission to a remote recipient. The invention provides a compact file containing all the elements sufficient to reproduce the screen and accompanying instructions including verbal or visual instruction and information. Compact files are best for transmission on low capacity data communication facilities such as over dial-up modems.

This invention relates to computer screen image and motion capture and in particular to a method for capturing and encoding computer screen image and motion plus added instructional information for transmission via electronic means to remote locations. The invention also includes a method for playing the encoded computer screen image.

### BACKGROUND

The plethora of new software applications and their ongoing upgrades has spawned an industry skilled in training computer users how to best use the myriad of features contained in application software that ever grows in complexity. An adjunct to training is the need to provide “help desk” facilities to support computer users that phone for assistance but who can subsequently receive e-mail advice as well.

Specific training sessions for computer users comprise a combination of verbal and instructional show and tell sessions. Ideally each computer user can then try to perform the same process on his or her own computer so as to reinforce each aspect and feature of the application software. When a user can not afford or is unable to attend such a training session, instructions can be recorded on videocassette and Compact Disc (CD) format. Thus a user can playback each instruction when and as often as they desire. Helpfully when the program is supplied on CD format each instruction is indexed and quick access is assured, otherwise the computer user can play the instructions from beginning to end stopping or repeating instructions when they desire.

Unfortunately, it is not always useful for a non-skilled computer user to rely on assistance obtained from a video or CD nor is every situation and instruction that may be needed by them provided on the video or CD. Hence there are “help lines” that allow a user to speak to a person skilled in the particular computer program who can explain how to perform the task at hand.

In both the prepared and real time help scenarios the capture and playback of the instructor's computer screen is used to illustrate and reinforce the required cursor movement and the particular functions actuated to perform each task.

There exist a number of products that provide what is generally termed “screen capture video”. Some products are being used for video playback during instructional sessions, others are used in the CD versions of instructional products and others are used to store and transmit the required tasks to the remote computer user who needs assistance by phone. The dear advantage of sending a computer user a recorded version of the required steps is that the user can not only see the moves themselves but they can store these steps away and play them again at any future time.

In certain WEB browser based applications, it may be advantageous to provide similar functionality but the file sizes created could cause unacceptable data transmission load and increase the possibility of discontinuous playback. Furthermore, it is generally not possible to save and then replay streaming files.

Most prior screen capture video products store bit map images of the screen (copy all of the pixel values displayed by the computer screen) at predetermined intervals (say one tenth of a second). Clearly this has a number of less than desirable features including the very large size of each screen grab (640 by 480 pixel array generates over three hundred thousand bytes of data at grey scale colour depth and three times that information for 16 Million colours). Each second of capture creates ten times the data described above.

This amount of data not only needs to be stored but if it needs to be transmitted elsewhere it can take a considerable time to do so using conventional modem technology of the day. This is so even if the file generated is compressed. Furthermore this method of capture will fail to capture some information that may have been useful, such as the change of a cursor from one symbol to another. It may also distort the movement of fast moving objects such that upon playback the cursor movement does not appear smooth.

In order to deal with the volume of data generated by each screen grab a general approach is to store only those pixel's that change from screen to screen. Assuming the capture is still at the rate of ten screens per second there will still be data absent and playback jerkiness can still arise. However, the computer needs to detect the difference between each screen.

The most basic approach to this task is for the computer to maintain a copy of the previous screen in a buffer and make a pixel by pixel comparison to determine the position and nature of the change and store that information in a Look Up Table (LUT). Each entry is time stamped so that the relevant change can be implemented during playback of the session thus recreating the each screen in succession.

The sophistication of current computer chips dedicated to such processing is such that moving pictures that provide cinema quality reproduction that is equivalent or exceeds film stock is now available for use in home theatre systems. Motion Picture Experts Group (MPEG) standards I and II with MPEG III and IV on the way include many techniques to compare and compress the digital data that comprises images (fast and slow moving across the screen) with high resolution and almost unmatched colour depth. Such sophistication is not however available to typical computer users and neither do they really need such detail. More so they do not want the still very large files sizes that are generated by such software even with the extensive use of compression.

Yet another way of capturing a screen is to record all the Application Programming Interface (API) codes used to generate the screen by the computer and encode all of the API function calls that call routines to perform all the screen display functions. The graphical API routines are executed in response to a plurality of graphical API function calls. The method comprises hooking the entire graphical API function calls so that when one of the graphical API routines is called the graphical API function call will be diverted to an encoding subroutine. If the graphical API function call was directed to the monitor, then a determination is made whether there are any dependent objects of the graphical API function call that need to be stored. If so, the dependent objects are stored in records. The graphical API function call is then stored in a record.

In fact ideally there is typically only a portion of the user's computer screen that is relevant to the computer user at the time, while it is typical to capture the whole screen thus contributing to large file sizes.

It is an aim of this invention to provide a method for providing a screen capture function that produces files that are small compared to prior screen capture products but that plays back with acceptable graphical reproduction quality. It is also an aim that the product of the method provides an alternative to current screen capture tools. It is a further aim to simultaneously capture audio that is included to describe the screen actions and which the person adds as they record the screen images. The audio provides relevant verbal instruction about the actions being taken and can usefully reinforce those actions. It is also an aim to provide similar functionality to that described above for WEB accessed tuition.

### BREIF DESCRIPTION OF THE INVENTION

In a broad aspect of the invention a computer screen capture method consists of the following steps:
a) capturing screen data representative of a selected area, being the whole or part of said computer screen, at predetermined capture intervals including the capture of the whole of said selected area of said screen at the beginning of this process;
b) comparison of each successive captured screen data with the immediately preceding captured screen data to determine the area of the screen that changes for each of said one or more predetermined areas of said selected area;
c) creation of an event list having an event interval at least equal to or less than the said predetermined capture interval containing none, one or more entries per interval, wherein said entries may be one or more of a unique reference to events representing visual change associated with said captured screen data;
d) recreation of previous and successive of said one or more areas of said selected areas by reference to associated events in said event list;
e) comparison of recreated previous and successive of said one or more areas to determine the minimum area of change and storing said minimum area or areas; and
f) creation of a file containing at least said first whole selected area and said minimum stored areas, and an event list representing changes over time of said selected area of a computer screen.

In a further aspect of the invention between steps e) and f) there is a further step of:
e′) comparing minimum stored areas and discarding multiple copies of said minimum stored areas and maintaining a store of unique minimum areas and adding to said event list a reference to said unique minimum areas for each respective associated event interval.

In yet a further aspect of the invention the further step of compressing the minimum stored areas before communicating those minimum stored areas over a computer network.

In a further aspect of the invention the event list is compressed before sending said event list over a computer network.

In a further aspect of the invention in accordance with any preceding aspect wherein said steps are performed on the fly.

In a yet further aspect of the invention in accordance with any preceding aspect wherein any step following step a) is performed after all storage steps have ceased.

A yet further aspect of the invention includes obtaining cursor image data that is obtained via an application programming interface call, storing that data and creating a reference to this data in the event list including the position of the cursor relative to the selected area.

It is a further aspect of the invention to playback the cursor motion by interpolating the position of a cursor and displaying it on the reconstructed screen more often than the screen is reconstructed.

In another aspect of the invention a computer screen playback method for playback of a computer screen captured in accordance with the method defined herein comprising the following steps:
a) receiving and uncompressing said compressed files;
b) displaying the whole of said selected area of said computer screen; and overlaying on to said display said one or more minimum areas of change as and when said change occurs in sequence as stored.

It is an aspect of the further aspect of the invention wherein playback of the cursor motion includes the step of: interpolating the position of a said cursor for positions between cursor capture intervals; and displaying said cursor on a said overlay more often than the screen is overlay is updated with said minimum areas.

It is an aspect of the further aspect of the invention wherein when the cursor position is interpolated and if the amount of interpolated movement between display positions of said cursor is less than twice the maximum linear dimension of the cursor icon dimension, an area of the current display screen that is less than twice the area of the cursor dimension is stored separately such that successive movement of the cursor between displayed positions uses said separately stored screen area to overlay said then current screen.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

### BREIF DESCRIPTION OF THE FIGURES

FIG. 1 depicts four frames of a computer screen captured at quarter second intervals showing an open CorelDRAW application partitioned by dotted lines;

FIG. 2 depicts column three of each of the frames depicted in FIG. 1;

FIG. 3 depicts the process of comparing the images in the same column of successive frames;

FIG. 4 depicts the isolation of unmatched area/s in the same column of successive frames;

FIG. 5 depicts isolated graphical information from columns that have changed from a previous column this results from the processes depicted in FIGS. 3 and 4;

FIG. 6 depicts a pictorial representation of the bit map images that are stored during recording of the sequence;

FIG. 7 depicts an arrow shaped cursor and its associated hot spot;

FIG. 8 depicts an “I” beam shaped cursor and its associated hot spot;

FIG. 9 depicts an intermediate process of reconstruction of frames from the previously recorded data and minimising the size of stored bit map images by identifying common and changed areas within columns;

FIG. 10 depicts the step of identifying the smaller bit map that can then be stored to represent the change from one frame to its subsequent frame; and

FIG. 11 depicts the processes involved in displaying the cursor for both fast and quick moving cursor movement.

### DETAILED DESCRIPTION OF EMBODIMENTS OF THE INVENTION

The invention is described using the example of a computer screen and how to capture screen changes and movement in a form that can be used to recreate those features of the screen as well as movement of a cursor that is being manipulated by an expert user for eventual playback to a lesser skilled computer user. However, the invention can be used in a program that can benefit any user wishing to capture their on screen actions, the accompanying sounds (music accompaniment) and even recordings of their own voices for storage or transmission to others. Furthermore, the invention can be used to modify the captured events by way of reordering or controlling the playback sequence, adding textural, audio and image based assistance files or even hypertext links to useful support information. In short an editing suite for manipulating recorded sequences.

It also makes no difference that the computer screen being recorded may be displaying one or more programs that could be a spreadsheet, graphical drawing, engineering design, language tuition, or the operating system of the computer itself. Each screen is at any one time only a collection of picture elements (pixel's) any portion of which can be stored and manipulated to recreate the screen at any future time.

The reproduction of the screen and in particular any movement such as cursor movement across the screen and pop up and drop down activation areas/buttons is necessary to the quality of reproduction required by, in this example, a lesser skilled user or the user themselves. However, no particular standard of reproduction is provided by the invention.

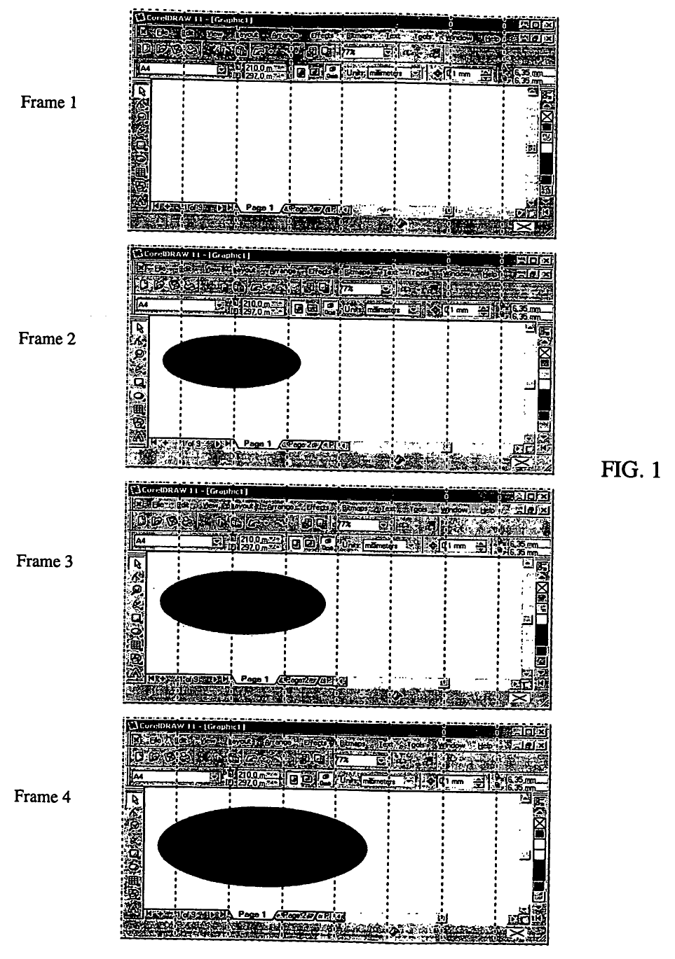

FIG. 1 depicts four consecutive frames of a computer screen image captured at a predetermined period of time apart. In this example the time period is one quarter of a second hence the four screens have been captured over a three quarter of a second period since the first screen is at t=zero seconds. Tick values are created from the available system ticks (it is not unusual for there to be 1000 ticks per second). Ticks thus represent 20 ms of time. To program for this feature the number of ticks per millisecond is used to set the interval so that four frames per second are captured.

In this example the area of the screen to be captured is the window of a CorelDRAW application which may or may not occupy the entire computer monitor screen. However, the invention can be arranged to record those changes that occur over any size and any particular area of the computer screen. For example, this may comprise a portion of the screen that incorporates an active application window as well as a portion of the background desktop area.

The ellipse shape depicted in the example (FIG. 1) is seen to appear and increase in size over the period of the capture.

The program once set to record a designated portion of the screen captures that portion at each predetermined interval and in this embodiment each successive screen is compared “on the fly ” during the recording process to determine those areas that have changed.

There is clearly a number of ways by which such a comparison can be made. In this embodiment the area is firstly partitioned into smaller areas than the area that has been captured. Equal width columns of 80 pixel's width have been used in this example however if the area is not equally divisible by 80 pixel's then the last column is less than 80 pixel's in width. As can be seen in the figures there are 8 columns across the width of the chosen area. The width of each column is variable however at this time a width of 80 pixels has been used.

The first column compared is the left hand most column starting at the first line (row) of pixel's down to the last, this is then repeated for each adjacent column until the last column is done.

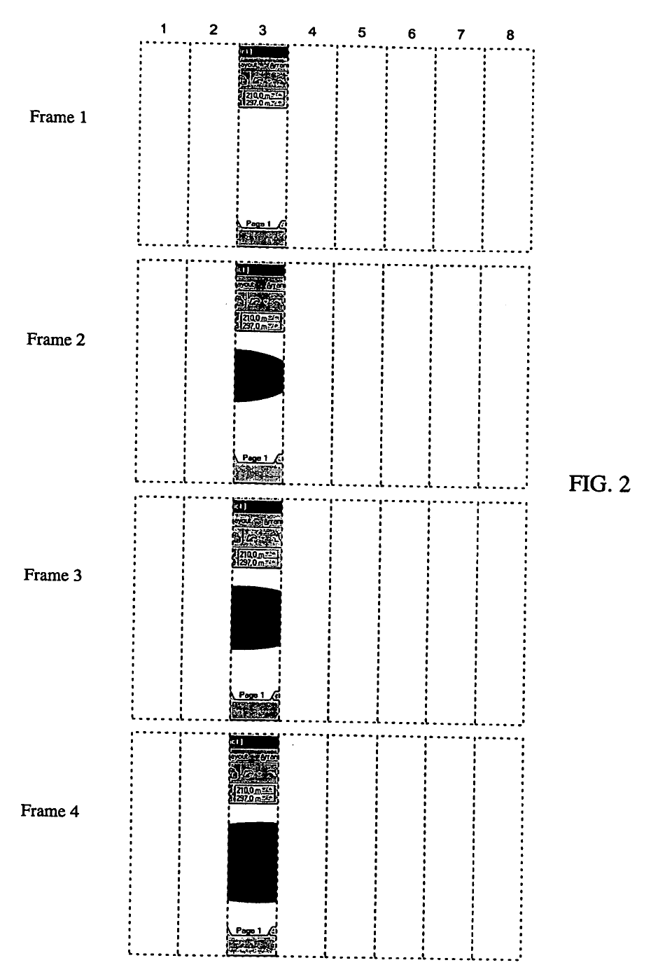

For illustrative purposes the process is shown in detail in FIG. 2 where the changes in column 3 of successive frames are illustrated. In the figures that make up FIG. 2 it can be seen that the top and bottom areas of the column remain the same while the oblate shape increases in area covering more and more of the column.

When a first change in a pixel value occurs the line in which the pixel changes is used as the upper boundary of the block having changed pixel's. The lower boundary is determined to be the line that is above (precedes) the line which is unchanged from the previous frame. Note that a pixel is just a triple of numbers representing the colour of that picture element (additional numbers are sometimes used to represent other characteristics) so the comparison is of raw numbers.

The block in column 3 is identified in respect of the total screen by at least two elements. The first is the position of the top left-hand corner of the block say x=300 and y=200 and the second is the bit mapped image (BMP) of width 80 by height 200 pixel's. However, it is possible to store this image in other formats. For example, the image could be stored in jpg or jpeg format using any suitable compression percentage. Different storage formats will provide generally smaller sized files than the BMP file format which can provide considerably smaller overall file size for transmission.

The first ever screen is saved in its entirety and located at x=0 and y=0 relative to the capture area not the screen area. The size of this block is obviously the maximum that needs to be stored and will be needed to begin the process of reconstructing successive frames.

It will be apparent that for each frame there will be a collection of (in this embodiment) BMPs of varying size stored in serial fashion with respect to the detected changes for each column in each frame. The nature of those BMPs is illustrated in FIGS. 3,4 and 5.

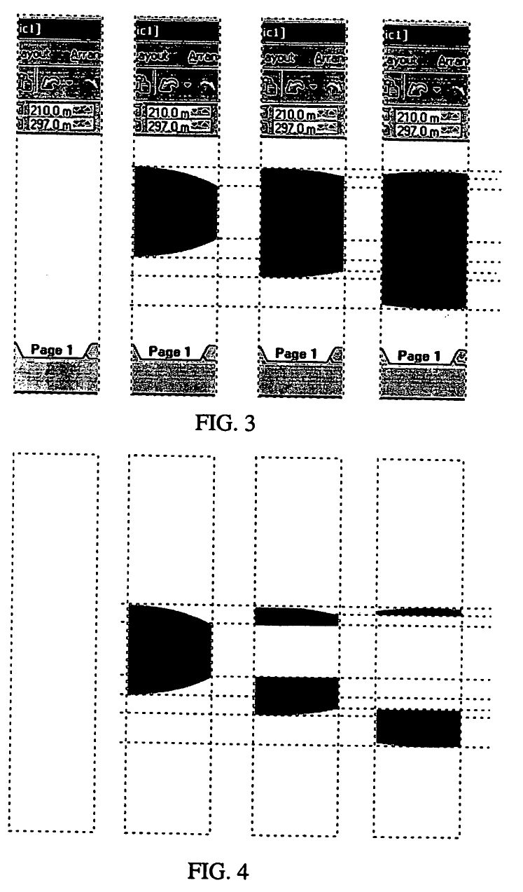

FIG. 3 depicts the exact changes for (the same column) in four successive frames while FIG. 4 depicts the BMP blocks that have changed by reference to the areas of the columns that have been compared and show a relevant difference.

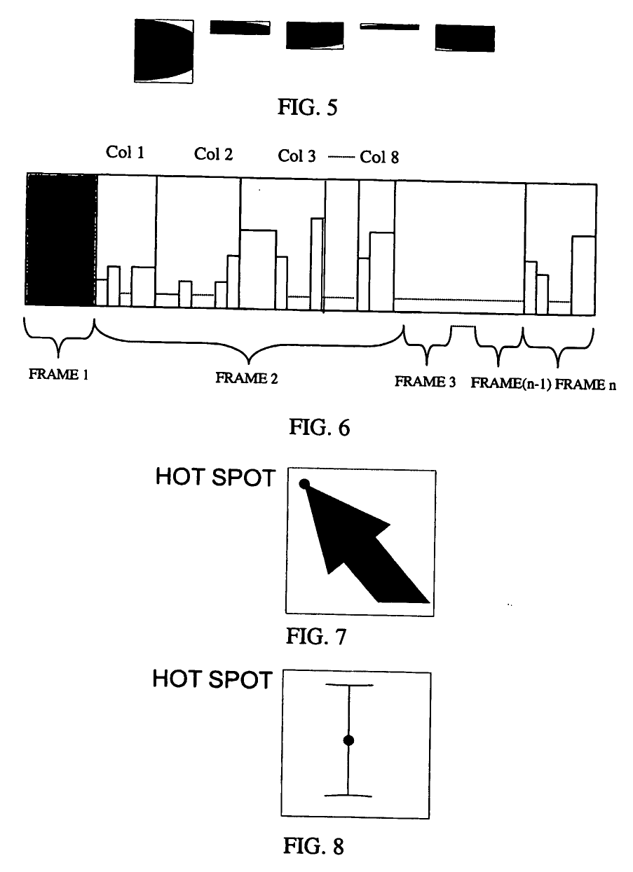

FIG. 5 depicts the actual BMP blocks saved during the recording process. The operations carried out are CPU intensive but not so much as to impede the operation of the computer being used to display the application. The computer is still able to support the recording and application manipulation being captured without decreasing the responsiveness of the computer.

FIG. 6 is a pictorial representation of the chronological collection of BMPs created during the recording phase. Such a file does not actually exist and FIG. 6 is merely a representation of the logical arrangement of all the stored graphical information.

The first frame is of course a BMP of the entire area being recorded. The second illustration is a captured BMP that represents the first area to change in column 1 of frame 2 there can be more than one BMP stored for each column for each frame. The remainder of the pictorial representation is representative of further frames and the BMPs stored in order of capture.

Programming of this feature however is likely to use an event list at the time of creation to enable coordination of the reconstruction process. An event list entry contains as preferred items:
a reference to a unique BMP stored separately (the creation of unique BMPs will be described later in the specification);
a cursor movement record (x, y);
cursor image reference;
screen size settings; and
audio volume changes.

These items are exemplary and do not constitute the maximum or minimum number of items or necessarily the most appropriate items. It will be noted that the stored BMPs are not explicitly listed in the event list as their storage is already ordered.

Creation of an event list is based on clock tick events, where none, one or more events representing visual change may be associated with each clock tick event that corresponds to a predetermined capture interval or just those events that coincide with a clock tick.

Each tick may or may not have a reference to one or more BMPs to reconstruct each frame in sequence and each tick may or may not have a cursor movement record, etc. This approach is an alternative to adding a time reference to each BMP and cursor image and thus requiring the storage of all BMPs deemed to represent changes in successive frames.

The event list and BMPs are kept in separate locations so as to keep the overhead information associated with each BMP to a minimum. With regards the cursors, a separate file is used to store all the relevant cursors used during the recorded sequence (typically 32 and 32 pixel BMPs).

The size of a recorded sequence is proportional to the length of the recording if the total BMPs for each frame are stored. At four frames per second there will soon be many bytes of data to be stored and eventually transmitted to a remote recipient. However, clearly if there is little change the number of stored BMPs will be less than if there was a large amount of change. The size of a recorded sequence is proportional to the length of the audio recording regardless of whether there is great or small amounts of sound.

As there is always a chance that some of the stored BMPs are the same, it would be advantageous to identify them and eliminate duplications. Each eliminated BMP would be replaced with a reference to the same BMP that can be stored separately for calling up by the event list when required.

It is merely a preferable addition to the processes described thus far that there can be further reductions in the quantity of data to be stored and transmitted by further comparison of the BMPs currently stored to identify common and different areas.

As the process of recording and comparison is ongoing it is also a feature of this embodiment that the cursor movement is recorded.

In this embodiment the cursor coordinates (x, y) are stored when a frame capture occurs. The cursor image is determined from API function calls and every time the cursor changes the new image is stored and the respective “hot spot” is stored with the cursor image data. The “hot spot” coordinate is that which is used to display the position of the cursor on the screen and is not necessarily the top left hand corner of the cursor image. All cursor data is stored in chronological order. Cursors are transparent BMPs. FIGS. 7 and 8 are examples of two cursors and the dot denotes the “hot spot” of each cursor.

To record sound creating a .WAV file is one way of recording and the file created can accompany the recorded screen display. The Microsoft Windows OS provides a standard 22 kHz WAV recording facility that can be initiated to record continuously during the screen capture process. It can record the audio created by the application being manipulated as well as that spoken by the user at the time of recording assuming they are using a properly arranged microphone. Or additional audio used to supplement or modify that which was previously recorded can be added. .WAV file recording is only one of many audio recording and playback possibilities. For example, MP3, ogg vorbis are alternatives.

In practical terms, but as measured by current technology, the CPU load can be high during the use of certain applications that need to be recorded. The recording process itself adds additional load, so the “on-the-fly” processing described above is importantly designed not to affect the responsiveness of the application being demonstrated. Thus, any additional processing to reduce the size of audio recording or BMP sizes can preferably be done when recording has ceased.

Thus in one example of how to further reduce the data required to be stored or sent, it is possible to reconstruct frames and compare the next BMP in the stream. Thus the previous fully reconstructed frame has the next BMP placed over it and common and uncommon areas are determined. The area of the next BMP to be placed on top of a fully reconstructed frame can then sometimes be reduced in size because there is an area of it that is common to the previous frame, within the existing width of the column. The comparison can be conducted in the same manner previously described.

It may be that the column width of the adjusted BMP is now reduced to a smaller size eg: 20 pixels width.

Clearly such an approach will further reduce the amount of data being stored as the average size of stored BMPs will reduce.

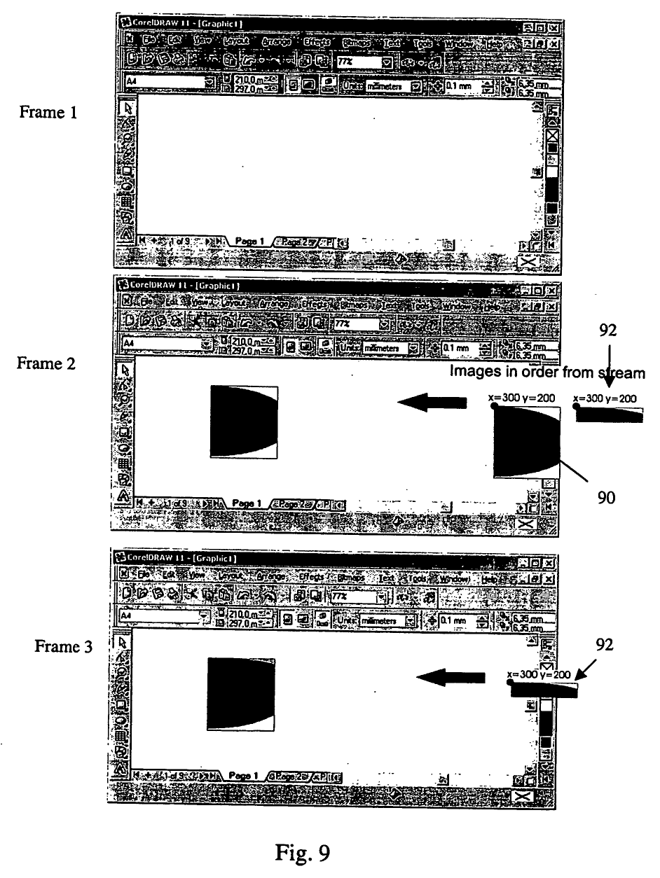

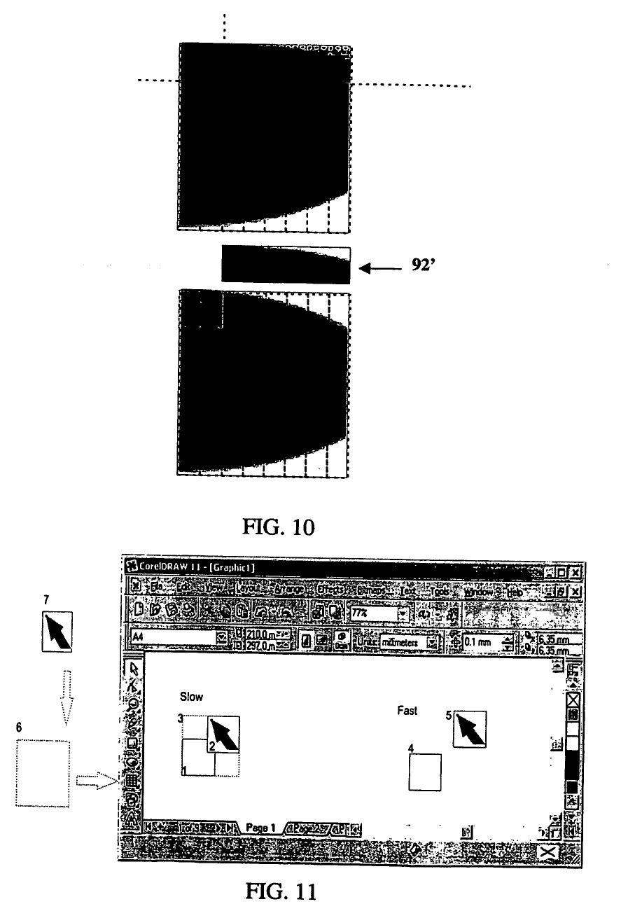

FIGS. 9 and 10 illustrate an example of how this approach can be implemented.

Frame 1 in FIG. 9 is the first whole BMP or jpg that is retrieved, over which each of the stored BMPs can be located in a timed sequence. This process is not unlike the creation of a collage, which in this case creates a moving picture.

Only the activity associated with column 3 is depicted in Frame 2. As such the time order of the BMPs indicates that BMP 90 is to be located at x=300 and y=200 of the Frame. BMP 90 as such is shown in place and a copy of BMP 90 is shown on the side of the frame as if waiting in line to get on to the frame. Also shown is BMP 92 which is not actually the next BMP to be placed on frame 2 but is actually in a group associated with the time interval relating to frame 3. As is apparent in this example, BMP 92 will cover part of BMP 90. It is the common area of cover of BMPs 90 and 92 (see FIG. 10) that is recognised as being superfluous to BMP 92 and can be discarded. A smaller BMP 92′ (FIG. 10) results.

This trimming process which may reduce the area of each BMP is particularly CPU intensive and as discussed is preferably done after the screen recording process. However, that is not to say that with appropriately efficient programming and processor power it could not be performed “on-the-fly” during the recording process.

So as to further reduce the size of the stored BMPs, header data is removed and only colour information, (x, y) location information, height and width data is kept. However by performing this process on many thousands of BMPs the reduction of data can be significant. Yet a further reduction of the quantity of data associated with the stored BMPs can be achieved by identifying BMPs that are same following the width trimming process.

One way by which this can be done is to calculate the Cyclic Redundancy Code (CRC) or hash of the colour values of all the pixel's in a BMP and compare the results to identify common BMPs. When common BMPs are eliminated, there will be a further reduction of the amount of data to be stored in the BMP data store. However, in the place of a removed BMP a reference to the remaining example of the common BMP is made so that the removed BMP can be substituted with the remaining BMP when required.

It is advantageous to have a facility to instantly play back the recorded screen capture if the receiving user does not have a compatible playback program. In which case it is possible to attach a copy of the playback software to the captured file. Once the file is double clicked to be opened the player self-extracts, installs on the users computer and plays the captured file. The play back software is arranged to reverse the processes described previously. It will be noted that since lossy compression is used the quality of the reproduced screen and associated features is less that the original. Various compression settings available either to the developer or the user at the time of making the recording are chosen so that the playback quality is acceptable. Since, quality judgement is typically subjective, the choices made will always be subject to change to suit the recipient.

A further reduction in overall file size is achieved using known compression technology. BMP images are amongst the easiest to compress using a known process called “zipping” as is available from WINZIP Computing. Substantially smaller files are achieved when zipping BMP file types particularly on commonly coloured BMPs ie-monochromatic BMPs e.g a grey scale BMP? Note, as previously mentioned, the BMPs files are separate from the event list file.

The zipped file is given a .ZIP file extension and the .ZIP file containing the BMP data is part of the total file collection that is communicated to the remote user. It is also possible to selectively compress captured files to jpg format which may be ZIPPED for convenience or conformity with a predetermined file generator procedure.

The sound that was captured previously can also be reduced in size by using known compression technology and it is preferable that the .WAV file is converted to a compressed file type, for example an MP3, ogg vorbis or other file type. Conversion programs allow the quality of replay to be determined by settings that adjust the bit rate at which the source is sampled ie -the .WAV file. The higher the quality (higher bit rate) the less reduction in size of the file created. Notably, high compression rates can still provide adequate aural reproduction but achieve substantial reductions in file size.

The final files sent to a recipient (user) will comprise a collection of files as described above and may also include a self contained, self extracting player file and the whole file may be ZIPPED for communications even though by then the majority of file reductions will have been achieved.

Sound and screen playback synchronisation is achieved by recognising firstly that there is likely to be a difference between the length of the compressed audio file recording and the screen capture sequence when played back. For example for relatively short recordings of say less than a minute, the difference in time may be of the order of half a second. This degree of difference does not seem to be noticeable by users. However, for recordings of a minute or more the delay can be seconds, which will be very noticeable by the end of the playback sequence.

In a preferred approach, to better synchronise these elements, every 120 ticks the event list items that would have been used are delayed until the next tick occurs. The choice of 120 ticks is a matter of experimentation although this value can be varied.

Playback of the captured, dipped and compressed screen sequence can be handled in a number of ways, the most basic being the linear playback where the sequence is played from beginning to end. All the BMPs are uncompressed in preparation for playback or uncompressed on the fly. In this playback case the first uncompressed BMP is a representation of the first stored complete screen BMP over which all subsequent uncompressed BMPs are located in time sequence. It is also possible to compress the initial image to a jpg format but any compression algorithm that is suitable for large initial files can be used. Reproduction quality acceptability determines the % of compression allowable, but 1 Mb to 27 kbyte size reduction is achievable and acceptable. The overlay of the cursor and audio synchronisation is as described previously.

However, the user may want to commence the playback at any point along the sequence. In that case, using the techniques described here in, there would need to be a delay in the provision of the wanted sequence to the user, as all previous frames need to be reconstructed from the very first frame to the beginning of desired playback sequence.

In practical terms the delay may be acceptable but it is also possible to capture complete screens at a different interval than the interval determined previously. For example, in addition to capturing four screens per second for processing in the manner described, full screens can be captured and their compressed files are separately stored every thirty seconds. Having the full screen available at thirty-second intervals means that the greatest delay in providing playback is caused in reconstruction from a maximum of thirty seconds previously. The reconstruction of course does not take thirty seconds but the reconstruction process uses a complete frame from a maximum of thirty seconds previous to the point in the sequence the playback is to begin from.

It may also be advantageous to allow playback only from the thirty-second points of time along the sequence period. All the reconstruction described in catching up to the point in the sequence the playback is to begin from is done in the memory and computer processor without being displayed. The user only sees the playback from the point they designate, which then is by design a predetermined full screen storage point.

It is an alternative to reconstruct selected whole frames at the point of playback. In other words pre-processing can provide complete frames (at predetermined intervals within the playback sequence) in memory prior to playback. Such an approach provides whole frames distributed throughout the playback sequence. A whole frame would only need to be reconstructed for every thirty-second period and this is considered sufficient to provide advantageous seek times for random access to the playback sequence. Such an approach eliminates having to previously save, compress and transmit complete screens thus keeping the number of stored complete images size to a minimum.

As described previously an event list is created and stored during the recording period. This list is used to synchronise the time when, the various complete images (Bus) are overlayed on the current frame, when the cursor is placed on the current screen and when one or more of the audio files are played. Other event items are also stored in the event list.

Of further assistance to the creator of files used for “help line” and “training” instructions is the ability to modify an existing recording. For example, it will be useful to the person receiving instructions to be able to click on a WEB page link included in the instructions after its initial recording. This is particularly so, if a more in depth explanation is available for review on the referenced source. Once, the person has finished reviewing the added supplementary information they can return to the prerecorded instructional file at the point they left it.

The types of objects that could be useful include:
the display of scrolling text
screen display zoom functionality
annotation in an identifiable object shape, for example a balloon—such annotation can include hyperlinks
media files—playable with commonly available applications such as Internet browser plug ins, Microsoft Media Player, Apple Quick Time, Flash etc.
audio files
cursor manipulations
application calls and commands for program's on the computer recipients

These objects and/or links to them are positioned over the playback screen area for review and activation by the recipient if they wish to utilize the additional features they provide.

So as to keep accompanying file sizes acceptably small, additional imaging is of the vector style.

Background music can also be added and its replay sequence can be controlled. A predetermined suite of background music files can be sent with the instructional file and the particular sequencing can be included in the instructional file. The size of music files that are able to be reproduced with surprisingly good reproduction quality is small relative to the other files being down loaded. It is therefore useful to incorporate this type of effect as it can enhance the effectiveness of the instructions provided.

The playback sequence can be further modified by the insertion of preset pauses or pauses that are conditional on actions or reactions by the receiving party. Or for portions of the presentation to be replayed etc.

Additional instruction or information can be processed in much the same way as the replay methodology developed for cursor movement representation that is described in detail later in the specification.

It is also intended that the above functionality or predetermined portion thereof are made available to the recipient of such instructional files to allow them to reply in a convenient manner using audio graphics, text and other descriptive techniques to explain their misunderstandings or needs for clarification.

Displaying the cursor during playback is handled in a preferred manner. The most basic approach would have been to playback the captured API calls and substitute the saved cursor icons at the appropriate times when it changes. The approach described if played back at the four per second rate, would likely provide a cursor movement that was not very smooth. Positional details that may be useful may not be displayed and the movement would not be pleasant to view.

In a preferred approach the cursor is displayed on the playback screen fifty times a second although this can be changed to reflect system capability or performance restrictions even though the cursor and its movement are recorded four times per second. The additional cursor image locations on the screen are in this invention embodiment are interpolated, using in this embodiment, a simple linear model for the movement between the previous and next cursor position. However, there is some difficulty in displaying the cursor on a frame that only changes four times a second as the cursor occupies a fixed area of pixels and that area may move at least twelve times before the next reconstructed frames is displayed.

One preferred approach is to take areas from the previous reconstructed frame (ie. that frame that is displayed during playback that represents the last quarter of a second of the sequence) and extract from it an area that is held separately in memory.

The extracted area can then be used to replace on screen the area the cursor moved from.

The cursor positions as stated previously are interpolated so their future position at any time is known. Thus it is possible to calculate what distance they will be apart between each display (ie. they are displayed at least twelve times every quarter of a second between frame reconstructions) in the embodiment described herein.

When the distance is less that a predetermined threshold of pixels (say 63 because this is just less than double the width of the standard cursor that is 32 pixels square) they will overlap. This is likely to occur when the cursor is moving slowly. A consequence of that is that the image behind the cursor needs to be replaced without showing the previous cursor position even though there is overlap of the cursors.

In this embodiment a predetermined area (for example 63 pixels by 63 pixels when the threshold is reached) is extracted from the last reconstructed frame beginning at the minimum x coordinate and minimum y coordinate of the two cursors and stored separately.

A first cursor image is placed on the displayed screen now showing the cursor in its first position. Then the second cursor image is placed over a copy of the extracted area in its second position that replaces the same area again but the cursor is now in its second position within that area.

While the cursor is moving slowly and the distance between cursor movements is below the threshold, it is more economical to extract as small an area as possible. Hence for example when the cursors (one fiftieth of a second apart) are 20 pixels apart the area can be reduced to a worst case of 52 by 52 pixels in area.

The area can be thought of as a moving window of varying size and shape within which successive cursors are located. The shape is determined by the offset of successive cursors. In FIG. 11 the shape is denoted in dotted lines and forms a square because the cursors are displaced diagonally however if they had been displaced laterally then the area would have been rectangular.

However, when the cursor is moving quickly over the screen the area that needs to be stored is only that area to be occupied by the cursor, so that it can be replaced when the cursor moves on. The stored area over writes the previous cursor image as illustrated in FIG. 11.

In fact there are a number of operations at work when the cursor is fast moving. The calculation of the distance between interpolated cursor positions determines both whether the threshold has been reached and where the cursor will be next. Once known, an area equal to the cursor area is extracted from its future position in the last fully reconstructed frame ready for replacing in the same position after the cursor has been displayed over that position.

The process of calculation, extraction and replacement is ongoing whether the cursor is moving slowly or quickly.

All the proceeding functionality is also capable of being included in a file that can be uploaded to a WEB server for serving to more that one person. Each person wishing to review the instructional file needs to have an appropriate WEB browser plug in and by clicking on the link to the file, the instructional file including audio and any additional objects are streamed to the person on their computer.

The recipient of the WEB served file is provided the data for reconstruction of the screen and other instructional data by way of a “streaming like” process. In a preferred manner, the data captured is processed in much the same way as described herein. However, the data is prepared for sending to the recipient in blocks that are of variable length and in a ZIPPED format. Only after the receipt and UNZIPPING of a predetermined quantity of blocks is the player initiated to begin the replay of the instructional information.

The process firstly examines the data being generated by the encoding process and uses one or more thresholds for various criteria. Those criteria include the time elapsed of the recorded sequence, and the quantity of uncompressed data generated during the capture of the sequence. If for example the uncompressed data is greater in quantity than, say 200 kbytes then that data is processed in accordance with the techniques described herein and further compressed in size into one or more ZIPPED files. The ZIPPED files need to be uniquely identified and given sequencing information before they are then sent to the recipient, so that they can be replayed in sequence. The criteria can be used independent or combined.

As mentioned previously, the sending of ZIPPED files is arranged to occur based on various thresholds being met at the WEB server end, hence the packet sizes sent in the ZIPPED format are of various sizes.

One or more of the ZIPPED files are received and saved to the users computer memory and the player unzips them and sequences them for playback. However, as soon as the first ZIPPED file containing the initial screen copy is available the first screen can be displayed. It has been noted that there is generally a delay in the activity associated with the instruction at its beginning. This works well as the “streaming like” process described above is able to receive additional ZIPPED blocks of information in the intervening time. These additional blocks are then prepared for replay and the recipient does not generally perceive any delay in the delivery of the instructional information.

The ability to provide this functionality via the WEB broadens the access of persons to assistance of this kind.

It will be appreciated by those skilled in the art, that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

1. A computer screen capture method consists of the following steps:
a) capturing screen data representative of a selected area, being the whole or part of said computer screen, at predetermined capture intervals including the capture of the whole of said selected area of said screen at the beginning of this process;
b) comparison of each successive captured screen data with the immediately preceding captured screen data to determine the area of the screen that changes for each of said one or more predetermined areas of said selected area;
c) creation of an event list having an event interval at least equal to or less than the said predetermined capture interval containing none, one or more entries per interval, wherein said entries may be one or more of a unique reference to events representing visual change associated with said captured screen data;
d) recreation of previous and successive of said one or more areas of said selected areas by reference to associated events in said event list;
e) comparison of recreated previous and successive of said one or more areas to determine the minimum area of change and storing said minimum area or areas; and
f) creation of a file containing at least said first whole selected area and said minimum stored areas, and an event list representing changes over time of said selected area of a computer screen.

2. A computer screen capture method in accordance to claim 1 wherein between steps e) and f) there is a further step of:
e′) comparing minimum stored areas and discarding multiple copies of said minimum stored areas and maintaining a store of unique minimum areas and adding to said event list a reference to said unique minimum areas for each respective associated event interval.

3. A computer screen capture method in accordance to claim 1 wherein in addition to step a) complete representations of said selected area are stored at predetermined storage intervals.

4. A computer screen capture method in accordance to claim 1 includes the further step of:
a) obtaining cursor image data that is obtained via an application programming interface call;
b) storing said cursor image data regarding said application programming interface calls and creating a reference to said data in said event list including the position of said cursor relative to said selected area.

5. A computer screen capture method in accordance to claim 4 includes the further step of:
i) determining the position of a said cursor by reference to a hot spot and the position of said hot spot relative to said selected area and associating a event list entry therewith.

6. A computer screen capture method in accordance to claim 4 includes the further step of:
j) storing an image of said cursor.

7. A computer screen capture method in accordance to claim 6 wherein said cursor image is stored as a transparent bit map image.

8. A computer screen capture method in accordance with claim 1 including the further step:
j) compressing said minimum stored areas before communicating said minimum stored areas over a computer network.

9. A computer screen capture method in accordance with claim 1 wherein said event list is compressed before sending said event list over a computer network.

10. A computer screen capture method in accordance with claim 1 wherein said steps are performed on the fly.

11. A computer screen capture method in accordance with claim 1 wherein any step following step a) is performed after all storage steps have ceased.

12. A computer screen capture method in accordance with claim 1 further comprising the step of:
k) a user of said computer screen capture method adding one or more instructional objects to one or more captured screen data.

13. A computer screen capture method in accordance with claim 12 wherein one or more of said added objects of an image are added using vector representation.

14. A computer screen capture method in accordance with claim 12 wherein one or more of said added objects of audio are added using a compressed audio file.

15. A computer screen capture method in accordance with claim 12 wherein one or more of said added objects include a pause that is conditional on the action of the recipient of said captured screen data.

16. A computer screen capture method in accordance with claim 9 wherein said compressed files are communicated to a WEB server for storage and streaming to a recipient upon demand.

17. A computer screen playback method for playback of a computer screen captured in accordance with the method of claim 1 comprising the following steps:
c) receiving and uncompressing said compressed files;
d) displaying the whole of said selected area of said computer screen; and
e) overlaying on to said display said one or more minimum areas of change as and when said change occurs in sequence as stored.

18. A computer screen playback method in accordance with claim 17 wherein playback of said captured screen data includes the further step of:
f) a user choosing to replay said captured screen from a predetermined capture interval;
g) said playback steps beginning from said first stored selected area and being displayed to said user after said predetermined capture interval is reached.

19. A computer screen playback method in accordance with claim 17 wherein playback of said cursor motion replacing step e) with the step of:
e′) said playback steps beginning from the closest in time complete representation of said stored selected area to said predetermined capture interval.

20. A computer screen playback method in accordance with claim 17 wherein playback of said cursor motion includes the step of:
h) interpolating the position of a said cursor for positions between cursor capture intervals; and displaying said cursor on a said overlay more often than the screen is overlay is updated with said minimum areas.

21. A computer screen capture method in accordance to claim 20 wherein when said cursor position is interpolated and if the amount of interpolated movement between display positions of said cursor is less than twice the maximum linear dimension of the cursor icon dimension, an area of the current display screen that is less than twice the area of the cursor dimension is stored separately such that successive movement of the cursor between displayed positions uses said separately stored screen area to overlay said then current screen.

22. An apparatus for computer screen capture and replay comprising:
one or more computers each including a display screen, processor and user input device for at least one of said computers for delineating an area of a said respective display screen to capture;
instructions for capturing screen data at predetermined capture intervals of said delineated area the first such capture including a representation of the whole of said delineated area of a said display screen;
instructions for comparison of each successive captured screen data with the immediately preceding captured screen data to determine the area of the screen changes for each of said one or more predetermined areas of the selected area;
instructions for creation of an event list having an event interval at least equal to or less than the said predetermined capture interval containing none, one or more entries per interval, wherein said entries may be one or more of a unique reference to events representing visual change associated with said captured screen data;
instructions for recreation of a previous and successive of said one or more areas of the selected area by reference to associated events in the event list;
instructions for comparison of recreated previous and successive of said one or more areas to determine the minimum area of change and storing said minimum area or areas; and
instructions for creation of a file containing at least said first whole selected area and said minimum stored areas, and an event list representing changes over time of said selected area of a computer screen.

23. A computer-readable media for computer screen capture for creating a presentation, the computer including a display screen, processor and user input device for delineating an area of said display screen to capture, the computer-readable media comprising:
instructions for capturing screen data at predetermined capture intervals of said delineated area the first such capture including a representation of the whole of said delineated area;
instructions for comparison of each successive captured screen data with the immediately preceding captured screen data to determine the area of the screen changes for each of said one or more predetermined areas of the-selected area;
instructions for creation of an event list having an event interval at least equal to or less than the said predetermined capture interval containing none, one or more entries per interval, wherein said entries may be one or more of a unique reference to events representing visual change associated with said captured screen data;
instructions for recreation of a previous and successive of said one or more areas of the selected area by reference to associated events in the event list;
instructions for comparison of recreated previous and successive of said one or more areas to determine the minimum area of change and storing said minimum area or areas; and
instructions for creation of a file containing at least said first whole selected area and said minimum stored areas, and an event list representing changes over time of said selected area of a computer screen.
